(19) United States
(12) Patent Application Publication
(10) Pub. No.: US 2017/0172332 A1
(43) Pub. Date: Jun. 22, 2017

(54) CURTAIN CLIP

(71) Applicant: GDF Holding Inc., Hamilton (CA)

(72) Inventors: Alexandre Legault, Hamilton (CA); Lindsay Willcox, Burlington (CA); Markus Andreas Hetzler, Stouffville (CA)

(21) Appl. No.: 15/381,543

(22) Filed: Dec. 16, 2016

Related U.S. Application Data
(60) Provisional application No. 62/270,626, filed on Dec. 22, 2015.

(51) Int. Cl. A47H 1/18; B64D 11/00; A47H 1/04

(52) U.S. Cl. CPC A47H 1/18; A47H 1/04; B64D 11/0023

(57) ABSTRACT

The present invention is a combination of a curtain clip and a curtain slide. The curtain clip includes a socket portion connected to a tab portion. The socket portion has a socket for receiving the ring of the curtain slide when the socket and ring are urged together. Resilient fingers in the clip socket define a slot for receiving the ring shank of the ring of the curtain slide. The body of the curtain clip has a tab portion for fastening to a curtain, either by sewing the tab to curtain, or inserting the tab portion in a pocket in the curtain.

This application claims priority from previously filed U.S. provisional patent application 62/270,626 filed Dec. 22, 2015 inventors Alexandre Legault and Lindsay Willcox under the title Curtain Clip.

### FIELD OF THE INVENTION

The present concept relates to detachable curtain clips and more particularly relates to curtain clips which attach to curtain rings and/or curtain sliders.

### BACKGROUND OF THE INVENTION

There are applications where curtains must be designed to be easily detachable from the curtain slider, the curtain ring and/or the curtain rod. These applications for example include modern day aircraft in which there are numerous curtains throughout the cabin separating off various parts of the cabin. There is also a similar requirement in passenger rail cars and in general applications requiring curtains to be easily attached and detached from the curtain rod. Presently most of the detachable curtain mechanisms include the use of metal snap buttons. These snap buttons are attached to curtain sliders and/or curtain rings in the case where the curtain is retractable and/or directly to the curtain rod where the curtains remain in a fixed position.

In applications such as in the aircraft industry and/or in the rail industry curtains located within the cabins are periodically removed for cleaning. In this case the curtains must easily be detachable from the curtain sliders, the curtain rings and/or from the curtain rods without damaging the curtain and also be easily put back into position.

Unfortunately the use of metal snap buttons has the drawback that upon repeatedly detaching the curtain material tends to tear away from the snap at the location of the metal snap buttons. Ultimately the damage to the curtain around the metal snap buttons results in premature failure of the curtain and the increased cost associated with replacement of damaged curtains.

Therefore there is a need for a curtain clip which is easily attached and detached to curtain sliders, curtain rings, and/or to the rod itself without damaging the curtain during repeated attaching and detaching.

### SUMMARY OF THE INVENTION

The present concept is a combination of a curtain clip and a curtain slide that includes:
a) a curtain clip which includes a socket portion connected to a tab portion;
b) a curtain slide which includes a ring with a ring shank;
c) the socket portion includes a clip socket for receiving the ring in clipping fashion when the clip socket and ring are urged together;
d) the clip socket further includes at least one set of front and rear resilient fingers wherein the separation between the fingers defines a slot for receiving the ring shank there-through by resiliently separating the front and rear resilient fingers when the clip socket and ring are urged together.

Preferably wherein the clip socket is adapted for housing and retaining a portion of the ring shank in an engaged position once the ring shank has passed through the slot and the fingers are in a rest position.

Preferably wherein the socket includes a landing ridge, the landing ridge for making initial contact with the ring and guiding the ring into the slot.

Preferably wherein the top of the resilient fingers defines a V-shaped valley, with the valley bottom located at the intersection of the slot and the resilient finger tips, such that the ring shank is guided down the V-shaped valley and into the slot when the clip socket and the ring are urged together.

Preferably wherein the clip socket includes chamfered side walls located on opposite sides of the socket, thereby guiding the ring shank into the valley bottoms when the clip socket and the ring are urged together.

Preferably wherein the tab portion is a planar portion for connecting to the top of a curtain.

Preferably wherein the tab portion is a thin planar portion adapted for sewing into the top of a curtain.

Preferably wherein the tab portion is a planar portion configured for placement into a pocket in the top of a curtain such that the clip socket is accessible for clipping to a ring.

Preferably wherein the ring is separated from the curtain clip by pulling the curtain clip and the ring away from each other thereby resiliently separating the front and rear resilient fingers when the clip socket and ring are urged apart.

Preferably wherein the curtain slider includes a head adapted for slidably engaging along a curtain track.

The present concept is also a curtain clip for use in attaching to a ring that includes:
a) body which includes a socket portion connected to a tab portion;
b) the socket portion defines a clip socket for receiving a ring in clipping fashion when the clip socket and ring are urged together;
c) the clip socket further includes at least one set of front and rear resilient fingers the separation between the fingers defines a slot for receiving a ring shank there-through by resiliently separating the front and rear resilient fingers when the clip socket and ring are urged together;
d) the clip socket adapted for housing and retaining a portion of the ring shank therein once the ring shank has passed through the slot and the fingers are in a rest position.

Preferably wherein the socket includes a landing ridge, the landing ridge for making initial contact with the ring and guiding the ring into the slot.

Preferably wherein the top of the resilient fingers defines a V-shaped valley, with the valley bottom located at the intersection of the slot and the resilient finger tips, such that the ring shank is guided down the V-shaped valley and into the slot when the clip socket and the ring are urged together.

Preferably wherein the clip socket includes chamfered side walls located on opposite sides of the socket, thereby guiding the ring shank into the valley bottom when the clip socket and the ring are urged together.

Preferably wherein the tab portion is a planar portion for connecting to the top of a curtain.

Preferably wherein the tab portion is a thin planar portion adapted for sewing into the top of a curtain.

Preferably wherein the tab portion is a planar portion configured for placement into a pocket in the top of a curtain such that the clip socket is accessible for clipping to a ring.

The present concept is also in combination a curtain clip and a curtain slide which includes:
a) a curtain clip which includes a body and a clip socket;
b) the body adapted for fastening to a curtain;
c) a curtain slide includes a ring which is moveable between a disengaged position and an engaged position such that in the engaged position the curtain slide is received within the clip socket;
d) the clip socket includes at least one resilient finger for retaining the ring portion in the engaged position wherein the fingers extend into a ring aperture to retain the curtain slide in the engaged position.

Preferably wherein the curtain slide is placed into the engaged position by urging the ring portion into the clip socket, wherein at least one finger is adapted to resiliently deflect thereby allowing the ring portion past the finger and into the clip socket.

Preferably wherein the clip socket includes a ridge with a ridge surface adapted to guide the ring portion of the curtain slide into the clip socket when the curtain clip and curtain slide are urged together.

Preferably wherein the tab portion of the body is a planar flat section adapted to be sewn into a curtain.

### BRIEF DESCRIPTION OF THE DRAWINGS

The present concept will be described by way of example only with reference to the following drawings in which:

FIG. 1 is a top front perspective view of a curtain clip.

FIG. 2 is a top front perspective view of a curtain clip in combination with a curtain slider, shown in dashed lines.

FIG. 3 is a top end plan view of a curtain clip.

FIG. 4 is front elevational view of a curtain clip.

FIG. 5 is a right side elevational view of a curtain clip.

FIG. 6 is a bottom end plan view of a curtain clip.

FIG. 7 is a schematic front elevational view of a curtain clip shown in dashed line disconnecting from a curtain slider.

FIG. 8 is a schematic right side elevational view of a curtain clip shown in dashed line connecting to a curtain slider.

FIG. 9 is a front elevational view of a curtain clip in combination with a curtain slider, shown in a connected position.

FIG. 10 is a right side elevational view of a curtain clip in combination with a curtain slider, shown in a connected position.

FIG. 11 is a schematic partial sectional top end view of a slider ring contacting the landing ridge of the curtain clip, causing the slider ring to rotate.

FIG. 12 is a schematic partial sectional top end view of a slider ring contacting the landing ridge of the curtain clip, causing the slider ring to rotate.

FIG. 13 is a schematic partial sectional top end view of a slider ring contacting the landing ridge of the curtain clip, causing the slider ring to rotate.

FIG. 14 is a schematic partial sectional top end view of a slider ring contacting the landing ridge of the curtain clip shown in a valley bottom position just before connecting to the curtain clip.

FIG. 15 is a schematic partial sectional top end view of a slider ring and curtain clip in a connected position.

FIG. 16 is a schematic perspective view of a curtain slider engaged in a curtain track of a curtain rod.

FIG. 17 is a schematic perspective view of a curtain clip in combination with a curtain slider engaged in a curtain track.

FIG. 18 is a schematic perspective view of numerous curtain clips fastened to curtain pleats and engaged with a curtain slider connected to a curtain rod.

FIG. 19 is a back elevational view of a curtain clip.

FIG. 20 is a top front perspective view of an alternate embodiment of a curtain clip.

FIG. 21 is a top front perspective view of a curtain clip in combination with a curtain slider, shown in dashed lines.

FIG. 22 is a top end plan view of a curtain clip.

FIG. 23 is a front elevation view of a curtain clip.

FIG. 24 is a right side elevation view of a curtain clip. The right side is the mirror image of the left side.

FIG. 25 is a bottom end plan view of a curtain clip.

FIG. 26 is a front elevation view of a curtain clip in combination with a curtain slider, shown in dashed lines.

### DETAILED DESCRIPTION OF THE PREFERRED EMBODIMENT

The present concept a curtain clip shown generally as 100 includes the following major components namely body 104, tab portion 106, socket portion 108, and clip socket 110.

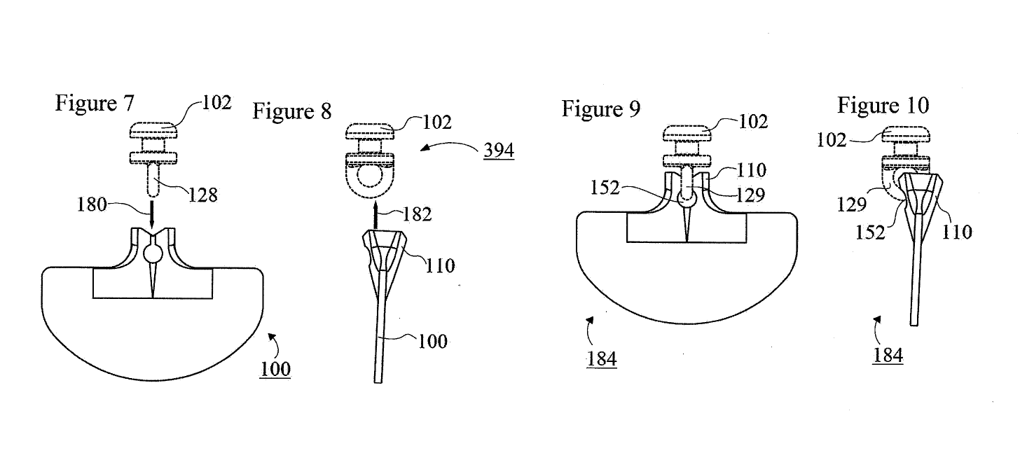

Clip socket 110 engages with the ring 120 of a curtain slider 102 as shown in FIG. 2 and also in FIGS. 7 through 10. Curtain slider 102 also includes a slider head 122, a slider shoulder 124, a slider relief 126, a slider ring 128 and a ring shank 129.

FIG. 2 also shows the longitudinal direction 140, the vertical direction 142 and the transverse direction 144 for later reference.

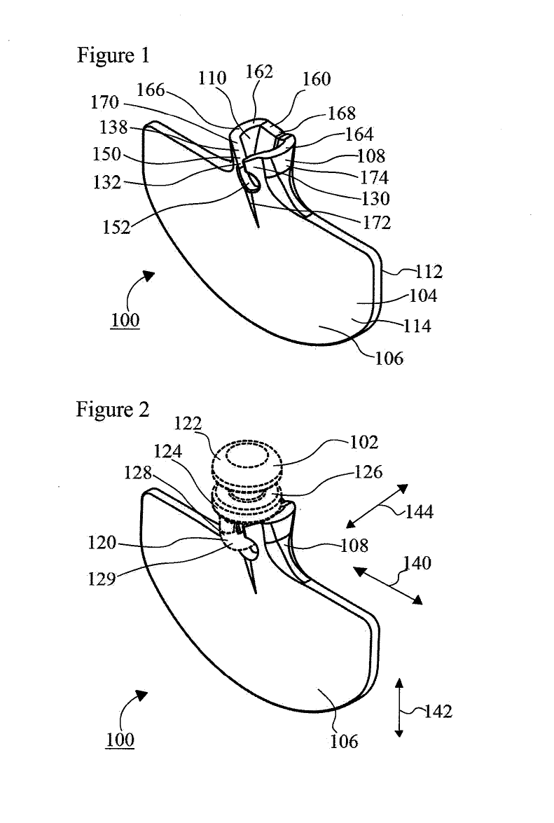

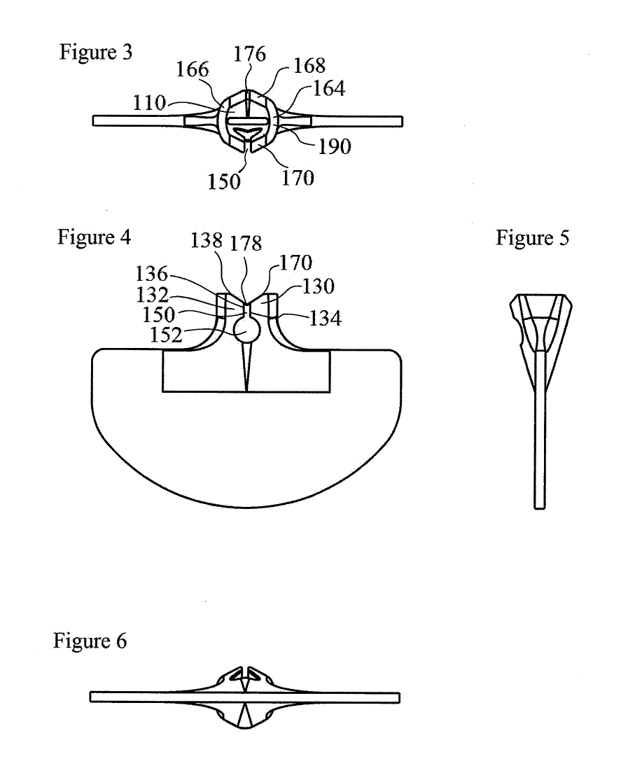

Referring now to FIGS. 1 through 6 more particularly clip socket 110 includes a right finger 130, a left finger 132, a right fingertip 134, a left fingertip 136 and finger tops 138.

Clip socket 110 further includes slot 150 which is the gap between the left fingertip 136 and the right fingertip 134 and ring opening 152.

Clip socket 110 further includes a saddle shaped landing ridge 160 which defines a ridge top surface 162 which includes the following features namely right ridge peak 164, left ridge peak 166, back ridge valley 168 and front ridge valley 170. The reader will note that clip socket 110 is a bowl shaped socket which is made up of side walls 174 which terminate at the ridge top surface 162 which is a saddle shaped landing ridge 160.

The reader will further note that back ridge valley 168 and front ridge valley 170 are preferably V-shaped terminating in a back valley bottom 176 in the case of back ridge valley 168 and a valley bottom 178 in the case of front ridge valley 170.

The reader will also note that the right ridge peak 164 and the left ridge peak 166 are preferably slightly convex having the highest portion peak 190 along the longitudinal direction 140 and falling off either side of the longitudinal direction 140 towards the backside 112 and/or the front side 114 of curtain clip 100.

From the drawings it would appear that the right ridge peak 164 and the left ridge peak 166 are flat which is also a possibility however preferably these ridge peaks 164 and 166 have a slight convexity to them and/or even a pronounced convexity.

Clip socket 110 as indicated can be used to clip to a ring 120 which may or may not be part of a curtain slider 102 as shown in FIGS. 2, 7-10, 16, 17 and 18.

In most instances ring 120 will be part of a curtain slider 102 however in some cases it may simply be a ring overtop of a curtain rod or a ring which is part of any number of attachment devices attaching curtains to curtain rods.

Is this specification we are using the example of a ring 120 attached to curtain slider 102 however the principles in attaching any type of a ring 120 to the clip socket 110 remains the same.

FIGS. 7, 8, 9 and 10 depict how a curtain slider 102 with a slider ring 128 connects and disconnects with the curtain clip 100.

FIG. 7 for example shows the disconnect direction 180 in which curtain clip 100 is pulled away from slider ring 128 of the curtain slider in order to disconnect the curtain slider from the curtain clip. FIG. 8 for example shows the connect direction 182 in which curtain clip 100 is pushed onto slider ring 128 in order to connect the slider ring 128 to the curtain clip 100.

FIG. 9 depicts the curtain slider 102 and curtain clip 100 in a connected position 184 in which the ring shank 129 of the slider ring 128 passes through the ring opening 152 of clip socket 110.

The reader will note that right fingers 130 and left fingers 132 are flexible and resilient and move apart when the ring shank 129 of the ring 120 of slider ring 128 is pushed through slot 150. The deflection of right and left fingers 130 and 132 helps guide the ring shank 129 into slot 150

Once the ring shank 129 has passed into ring opening 152 the right finger 130 and left finger 132 relax and go back to the rest position as shown in FIG. 1.

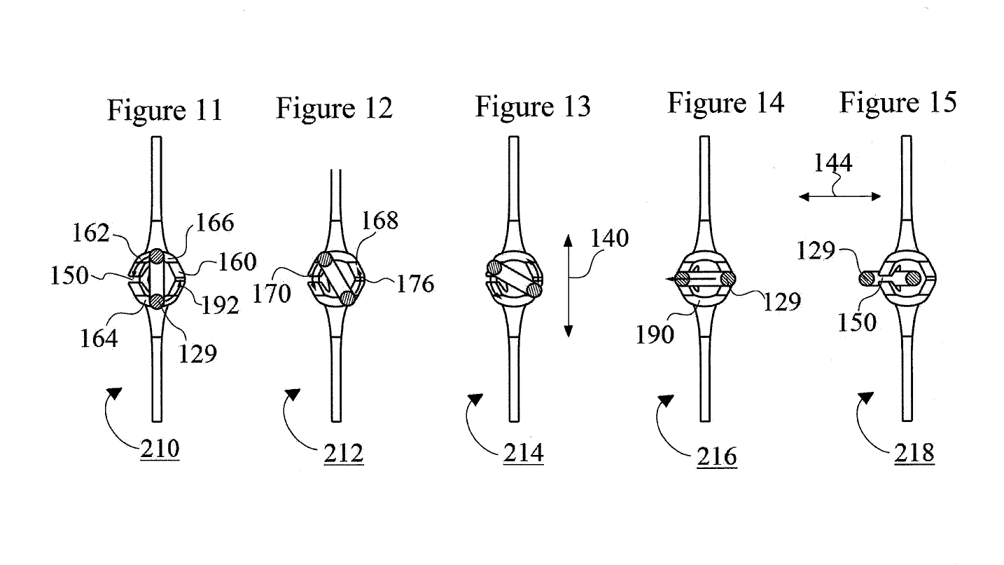

Referring now to FIGS. 11 through 15 which show the ring 120 which may or may not be part of a curtain slider 102 making contact with the saddle shaped landing ridge 160 namely ridge top surface 162 and rotating until the ring 120 is lined up in the transverse direction 144 such that ring shank 129 can then pass through slot 150.

FIG. 11 for example shows the ring shank 129 in the peak top position 210 in which the ring shank is aligned along the longitudinal direction 140. In this position the ring shank makes contact with the ridge top surface 162 at the peak 190 or the uppermost portion of the right ridge peak 164 and the left ridge peak 166. In this situation because the ridge top surface 162 falls away from the ridge peak 190 the ring shank 129 will rotate either counter clockwise 192 as shown or clockwise and move down along the right ridge peak 164 and the left ridge peak 166 until it reaches the peak intermediate position 212 shown in FIG. 12 and ultimately the ring shank will continue to rotate as it moves down the back ridge valley 168 and the front ridge valley 170 to a valley intermediate position 214 and will continue to rotate until the ring shank 129 is in the valley bottom position 216 making contact with the back valley bottom 176 and the front valley bottom 178 in which the ring shank is now impinging upon the slot 150 thereby pushing apart the resilient right finger 130 and resilient left finger 132 such that the ring shank 129 can now pass through the slot 150 and move into the connected position 218 shown in FIG. 15.

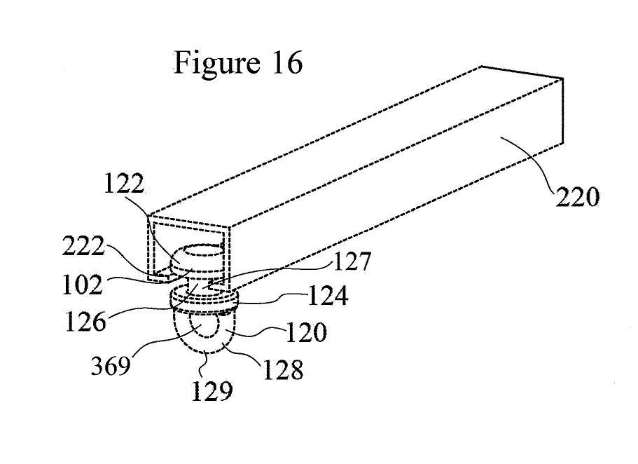

The reader will note that curtain slider 102 has the ability to rotate within curtain rod 220 as shown in FIG. 16. When ring shank 129 makes contact with ridge top surface 162 due to the saddle shaped landing ridge 160 and the contours of the ridge top surface 162 it will tend to rotate as previously described and depicted in FIGS. 11 through 15 until it is in the valley bottom position 216.

The reader will note that the curtain sliders 102 are normally housed within a curtain rod 220 and therefore the curtain clip 100 is normally moved relative to the curtain slider 102 by either pushing the curtain clip 100 towards the curtain slider 102 or pulling the curtain clip 100 away from the curtain slider 102 thereby connecting and/or disconnecting the curtain slider 102 from the curtain clip 100.

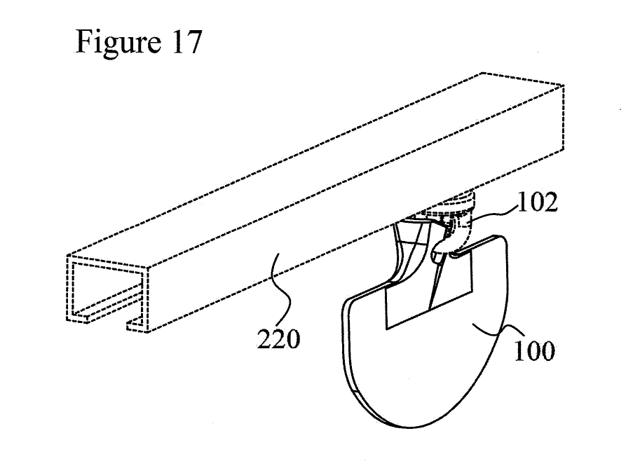

FIG. 16 shows a curtain slider 102 mounted onto a curtain track 222 which is part of a curtain rod 220. FIG. 17 shows a curtain clip 100 connected to a curtain slider 102 which is engaged in a curtain rod 220.

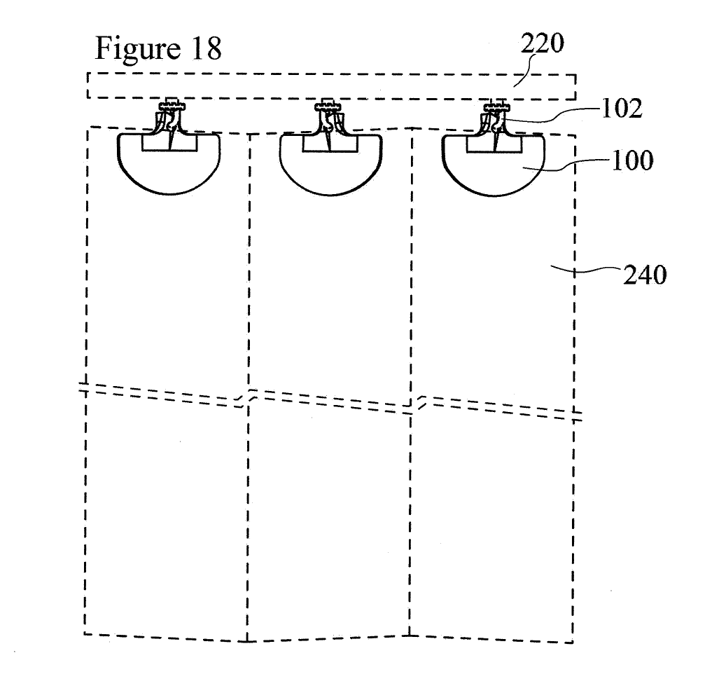

FIG. 18 shows a number of curtain clips 100 connected to curtain pleats 240. The connection between the curtain and the curtain clip 100 can be accomplished in a number of different ways. For example the tab portion 106 of curtain clip 100 can be sewn into curtain pleat 240. Another method would be to create a pocket within curtain pleat 240 made of material in which the curtain clip 100 could be slipped into thereby retaining the curtain clip within the pocket (not shown) of curtain pleat 240.

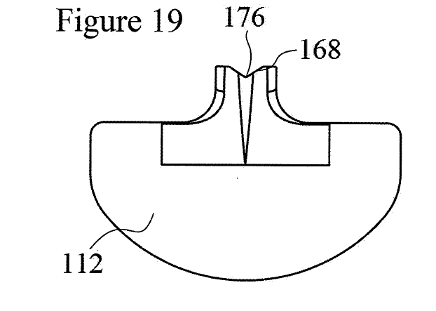

It may also be possible to adhesively connect the tab portion 106 of curtain clip 100 to curtain pleat 240. FIG. 19 shows the backside 112 of curtain clip 100 and the back ridge valley 168 and the back valley bottom 176.

By selecting materials providing the required resiliency for right finger 130 and left finger 132 as well as by selecting the thickness of sidewalls 174 one can easily fine tune and adapt clip socket 110 to provide a preselected amount of clipping strength in other words the amount of force required to put the clip into the connected position 184 or the disconnected position 180 shown in FIGS. 7 and 9.

Selecting certain material properties of curtain clip 100 and also by selecting different sidewall thickness 174 of clip socket 110 it is possible to obtain varying degrees of resiliency of left and right fingers 132, 130 and retaining strength of the clip.

### Alternate Embodiment

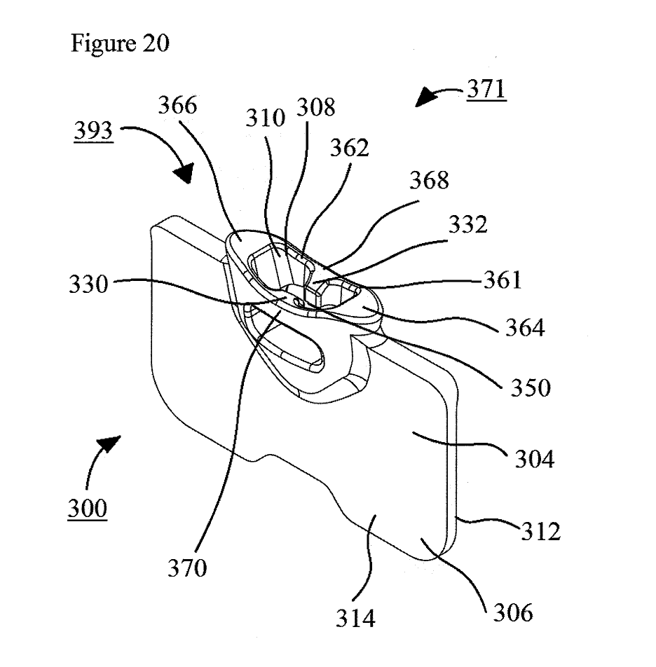

An alternate embodiment of a curtain clip is shown generally in FIG. 20 as 300 includes the following major components namely body 304, tab portion 306, socket portion 308 and clip socket 310.

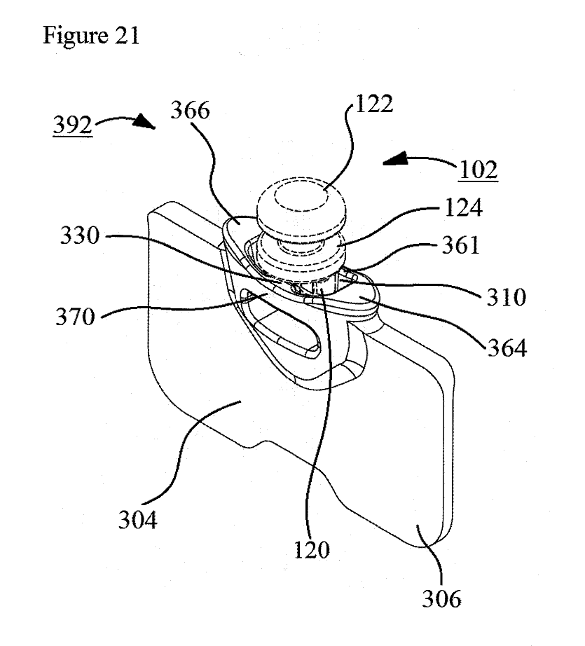

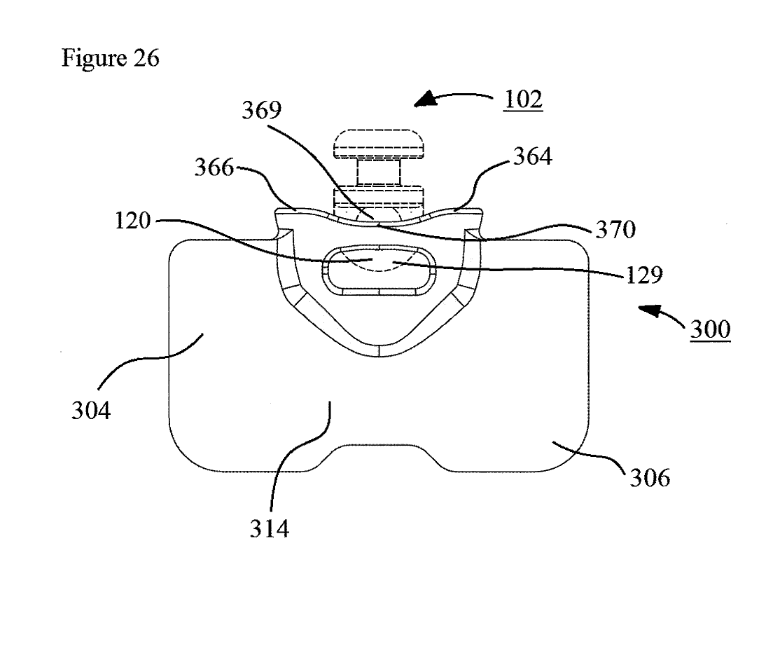

Clip socket 310 engages with the ring 120 of a curtain slider 102 as shown in FIG. 21 and also in FIG. 26.

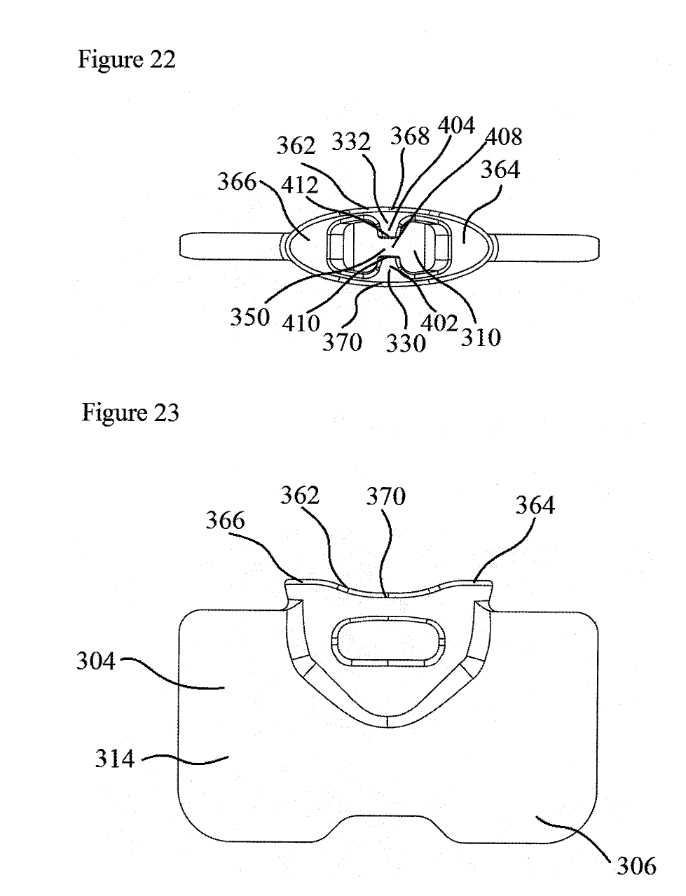

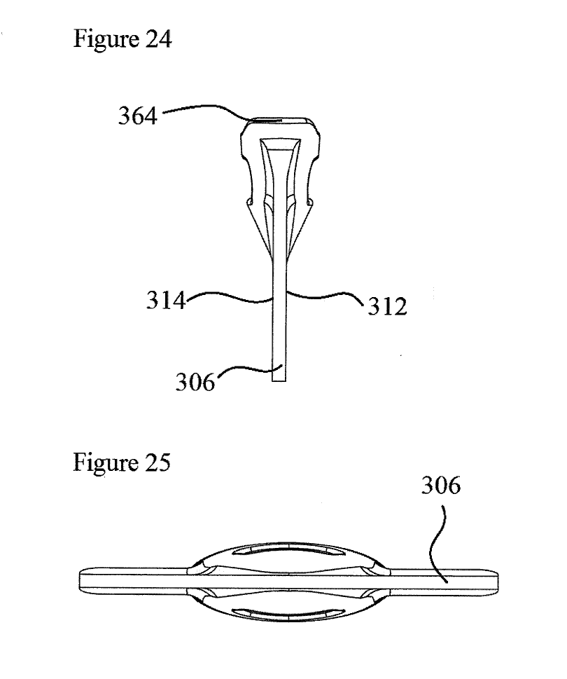

Referring now to FIGS. 20 through 25 more particularly clip socket 310 includes a front finger 330, a rear finger 332, a right ridge peak 364, and a left ridge peak 366. Front finger 330 and rear finger 332 are arranged in horizontally opposed fashion as illustrated.

Clip socket 310 further includes slot 350 which is the gap between the front finger 330 and rear finger 332.

Clip socket 310 further includes a landing ridge 361 which defines a ridge top surface 362 which includes the following features namely right ridge peak 364, left ridge peak 366, rear ridge valley 368 and front ridge valley 370.

Clip socket 310 can be used to clip to a ring 120 which may or may not be part of a curtain slider 102 as shown in FIGS. 21 and 26. In some instances, ring 120 may be a ring which is part of a curtain rod or other device that attaches curtains to curtain rods.

An example of a ring 120 attached to a curtain slider 102 is used for this specification however the principles in attaching any type of ring 120 to the clip socket 310 remain the same.

When ring 120 makes contact with ridge 361 namely ridge surface 362 while aligned in the traverse direction 144 deflection from rear finger 332 and front finger 330 will cause ring shank 129 to rotate either counterclockwise or clockwise until ring shank 129 is aligned in the longitudinal direction 140.

Ring shank 129 will move down along right ridge peak 364, left ridge peak 366, rear ridge valley 368 and front ridge valley 370 until it impinges on slot 350 and pushes apart rear finger 332 and front finger 330 so that ring shank 129 can pass through slot 350 and rest in the engaged position 392. Once ring shank 129 has passed through slot 350, front finger 330 and rear finger 332 relax and go back to the rest position 371 shown in FIG. 20 while impinging into the ring aperture, thereby keeping the ring 120 releaseably attached to the curtain clip 300.

Curtain clip 300 is placed in the engaged position 392 by pushing curtain clip 300 towards the curtain slider 102 and is disconnected and placed in the disengaged position 393 by pulling curtain clip 300 away from curtain slider 102.

### In Use

The discussion above regarding curtain clip 100 applies to curtain clip 300 in the way it functions except that curtain clip 300 has slightly modified finger positioning. Functionally curtain clip 300 operates in similar fashion as described for curtain clip 100. In engaged position 392 front and rear fingers 330, 332 extend into the ring aperture 369 to retain the curtain slide 102 in the clip socket 310.

When ring shank 129 makes contact with ridge surface 362 and the contours of the left ridge peak 366 and right ridge peak 364 it will rotate until it is aligned in the longitudinal direction 140 and impinge into slot 350.

The curtain clip 300 includes a socket portion 308 connected to a tab portion 306. The curtains slide 102 includes a ring 120 with ring shank 129. The socket portion 308 includes a socket 310 for receiving the ring 120 in clipping fashion when the clip socket 310 and ring 120 are urged together. The clip socket 310 includes at least one set of front and rear fingers 330, 332. The space between front finger 330 and rear finger 332 defines a slot 350 for receiving the ring shank 129 there-through by resiliently separating when the socket 310 and ring 120 are urged together.

Socket 310 also include a landing ridge 360 for making initial contact with the ring 120 and guiding ring 120 into slot 350. Front finger top 402 and rear finger top 404 defines a V-shaped valley 406 with the valley bottom 408 located at the intersection of slot 350, front fingertip 410 and rear fingertip 412. Chamfered side walls 414 are located on opposite sides of socket 310. Ring shank 129 is also guided down V-shaped valley 406 by chamfered side walls 414 toward valley bottom 408 and into slot 350 when clip socket 310 and ring 120 are pushed together.

The clip socket 310 is adapted for housing and retaining a portion of the ring shank 129 therein in an engaged position 392 once the ring shank has passed through the slot 350 and the fingers 330, 332 are in a rest position 371.

The socket 310 includes a landing ridge 361, the landing ridge for making initial contact with the ring 120 and guiding the ring into the slot 350.

The top of the resilient fingers 402 and 404 defines a V-shaped valley 406, with the valley bottom located at the intersection of the slot 350 and the resilient finger tips 410, 412, such that the ring shank 129 is guided down the V-shaped valley 406 and into the slot 350 when the clip socket and the ring are urged together.

The clip socket includes chamfered side walls 414 located on opposite sides of the socket, thereby guiding the ring shank 129 into the valley bottom when the clip socket and the ring are urged together.

The tab portion 306 is a planar portion for connecting to the top of a curtain.

The tab portion is a thin planar portion adapted for sewing into the top of a curtain.

The tab portion is a planar portion configured for placement into a pocket in the top of a curtain such that the clip socket is accessible for clipping to a ring.

The ring is separated from the curtain clip by pulling the curtain clip and the ring away from each other thereby resiliently separating the front and rear resilient fingers when the clip socket and ring are urged apart. The curtain slide 102 includes a head 122 adapted for slidably engaging along a curtain track 222.

The connection between the curtain clip 300 and a curtain can be achieved in many different ways. The tab portion 306 is a thin planar portion adapted for sewing into the top of a curtain. Tab portion 306 can be sewn in a curtain pleat or a pocket could be created in a curtain pleat within which the curtain clip 300 could be retained.

The backside 312 of tab portion 306 of curtain clip 300 could also be adhesively fastened to a curtain pleat.

In practice is has been found that a wide variety of currently available plastics are suitable for producing curtain clip 100 and curtain clip 300. A preselected amount of clipping strength can be provided by selecting materials that provide the required resiliency for front finger 330 and rear finger 332 as well as by selecting an appropriate thickness of sidewalls 374.

I claim:

1. In combination a curtain clip and a curtain slide comprises:
a) a curtain clip which includes a socket portion connected to a tab portion;
b) a curtain slide which includes a ring with a ring shank;
c) the socket portion includes a clip socket for receiving the ring in clipping fashion when the clip socket and ring are urged together;
d) the clip socket further includes at least one set of front and rear resilient fingers wherein the separation between the fingers defines a slot for receiving the ring shank there-through by resiliently separating the front and rear resilient fingers when the clip socket and ring are urged together.

2. The combination claimed in claim 1 wherein the front and rear resilient fingers are mounted in horizontally opposed to each other.

3. The combination claimed in claim 1 wherein the clip socket adapted for housing and retaining a portion of the ring shank therein in an engaged position once the ring shank has passed through the slot and the fingers are in a rest position.

4. The combination claimed in claim 1 wherein the socket includes a landing ridge, the landing ridge configured for making initial contact with the ring and guiding the ring into the slot.

5. The combination claimed in claim 1 wherein the top of the resilient fingers defines a V-shaped valley, with the valley bottom located at the intersection of the slot and the resilient finger tips, the V shaped valley adapted to guide the ring shank down the V-shaped valley and into the slot when the clip socket and the ring are urged together.

6. The combination claimed in claim 5 wherein the clip socket includes chamfered side walls located on opposite sides of the socket which are configured for guiding the ring shank into the valley bottoms when the clip socket and the ring are urged together.

7. The combination claimed in claim 1 wherein the tab portion is a planar portion for connecting to the top of a curtain.

8. The combination claimed in claim 1 wherein the tab portion is a thin planar portion adapted for sewing into the top of a curtain.

9. The combination claimed in claim 1 wherein the tab portion is a planar portion configured for placement into a pocket in the top of a curtain such that the clip socket is accessible for clipping to a ring.

10. The combination claimed in claim 1 wherein the ring is separated from the curtain clip by pulling the curtain clip and the ring away from each other wherein the front and rear resilient fingers are adapted to resiliently separate allowing the ring shank to pass through the slot when the clip socket and ring are urged apart.

11. The combination claimed in claim 1 wherein the curtain slide includes a head adapted for slidably engaging along a curtain track.

12. A curtain clip for use in attaching to a ring; the curtain clip comprises:
a) body which includes a socket portion connected to a tab portion;
b) the socket portion defines a clip socket for receiving a ring in clipping fashion when the clip socket and ring are urged together;
c) the clip socket further includes at least one set of front and rear resilient fingers the separation between the fingers defines a slot adapted for receiving a ring shank there-through by resiliently separating the front and rear resilient fingers when the clip socket and ring are urged together;
d) the clip socket adapted for housing and retaining a portion of the ring shank therein once the ring shank has passed through the slot and the fingers are in a rest position.

13. The curtain clip claimed in claim 12 wherein the socket includes a landing ridge, the landing ridge adapted for making initial contact with the ring and guiding the ring into the slot.

14. The curtain clip claimed in claim 12 wherein the top of the resilient fingers defines a V-shaped valley, with the valley bottom located at the intersection of the slot and the resilient finger tips, wherein the V-shaped valley adapted for guiding the ring shank down the V-shaped valley and into the slot when the clip socket and the ring are urged together.

15. The curtain clip claimed in claim 13 wherein the clip socket includes chamfered side walls located on opposite sides of the socket, chamfered side walls adapted to guide the ring shank into the valley bottom when the clip socket and the ring are urged together.

16. The curtain clip claimed in claim 12 wherein the tab portion is a planar portion adapted to connect to the top of a curtain.

17. The curtain clip claimed in claim 12 wherein the tab portion is a thin planar portion adapted for sewing into the top of a curtain.

18. The curtain clip claimed in claim 12 wherein the tab portion is a planar portion configured for placement into a pocket in the top of a curtain such that the clip socket is accessible for clipping to a ring.

19. In combination a curtain clip and a curtain slide comprises:
a) a curtain clip which includes a body and a clip socket;
b) the body adapted for fastening to a curtain;
c) a curtain slide includes a ring which is moveable between a disengaged position and an engaged position such that in the engaged position the curtain slide is received within the clip socket;
d) the clip socket includes at least one resilient finger for retaining the ring portion in the engaged position wherein the fingers extend into a ring aperture and are adapted to retain the curtain slide in the engaged position.

20. The combination claimed in claim 19 wherein the curtain slide is placed into the engaged position by urging the ring portion into the clip socket, wherein at least one finger is adapted to resiliently deflect thereby allowing the ring portion past the finger and into the clip socket.

21. The combination claimed in claim 20 wherein the clip socket includes a ridge with a ridge surface adapted to guide the ring portion of the curtain slide into the clip socket when the curtain clip and curtain slide are urged together.
